(19) United States
(12) Patent Application Publication
(10) Pub. No.: US 2007/0051341 A1
(43) Pub. Date: Mar. 8, 2007

(54) Fuel supply system

(76) Inventors: Masayuki Daikuhara, Odawara-shi (JP); Keisuke Namibe, Odawara-shi (JP); Toru Tsuchiya, Odawara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/574,940

(22) PCT Filed: Oct. 21, 2004
(86) PCT No.: PCT/JP04/15617

§ 371 Date: Apr. 7, 2006

(30) Foreign Application Priority Data
Oct. 24, 2003 (JP) 2003-364344

(51) Int. Cl. F02M 69/00

(52) U.S. Cl. 123/402

(57) ABSTRACT

The present invention provides a fuel supply system which can supply fuel accurately in accordance with driving conditions, while achieving cost reduction by adopting an inexpensive pump without a fuel return passage for returning surplus fuel.

A positive displacement pump which intakes and discharges a specific volume of fluid is adopted as the fuel pump 40, and discharges the amount of fuel needed for the injector 30 to inject. The fuel pump 40 is located outside the vapor separator 20. The discharged fuel from the fuel pump 40 is supplied to the injector 30 through the returnless pressure regulator 50. With this structure, the temperature rising of the fuel in the vapor separator 20 due to disposing the high pressure fuel pump and the pressure regulator within the vapor separator 20 can be prevented, and the connecting passage for connecting the pressure regulator and the vapor separator can be eliminated.

### TECHNICAL FIELD

The present invention relates to a fuel supply system which supplies fuel from a fuel tank to an injector.

### BACKGROUND ART

A fuel supply system for supplying fuel from a fuel tank to an injector is adopted to land vehicles such as automobiles, motorcycles etc. and marine vehicles such as outboard engines etc. For example, the following structure of a fuel supply system for an outboard engine for a marine vehicle is disclosed in Japanese Patent Laid-Open 2003-97377 (page 3 and FIG. 5). A fuel tank is attached to the hull side and various structure parts for supplying fuel which is introduced from the fuel tank to an injector are disposed at the outboard engine side.

A schematic diagram of the fuel supply system for an outboard engine of the prior art is shown in FIG. 4. A fuel tank 12 is attached to a hull 10 side. A low pressure filter 16, a low pressure fuel pump 18, and a vapor separator 20 as a vapor-liquid separating means are disposed and connected in order and in series at an outboard engine 14 side. The fuel tank 12 at the hull 10 side and the low pressure filter 16 at the outboard engine 14 side are connected through a hose 22a. Here, although it is not disclosed in the prior art, it is common to dispose a priming pump (not shown in figures) at some midpoint of the hose 22a at the hull 10 side.

The low pressure filter 16 and the low pressure fuel pump 18 are connected through a hose 22b. The low pressure fuel pump 18 and the vapor separator 20 are connected through a hose 22c. Fuel from the fuel tank 12 is supplied towards the vapor separator 20 through the priming pump (not shown in figures) and the low pressure fuel pump 18. In the vapor separator 20, the vapor contained in the fuel is eliminated and the fuel which had the vapor eliminated is accumulated. Since fuel at high pressure cannot travel between the hull 10 and the outboard engine 14, the vapor separator 20 for eliminating vapor from fuel is disposed at the outboard engine 14 side.

A high pressure fuel pump 24 and a pressure regulator 26 are disposed in the vapor separator 20. Apart of the high pressure fuel pump 24 is sunk below the fuel level 28 of the fuel accumulated in the vapor separator 20. The pressure regulator 26 is disposed above the fuel level 28. The high pressure fuel pump 24 and the pressure regulator 26 are connected through the hose 22d. Fuel accumulated in the vapor separator 20 is transferred outside the vapor separator 20 from the high pressure fuel pump 24 through the pressure regulator 26, and eventually introduced to an injector 30.

The pressure regulator 26 feeds the needed amount of fuel towards the injector 30 at a specific fuel pressure, and returns surplus fuel generated at the pressure regulator 26 towards the inside of the vapor separator 20 from the pressure regulator 26 via a hose 22e. The high pressure fuel pump 24 supplies to the pressure regulator 26 more fuel than the amount of fuel fed to the injector 30 from the pressure regulator 26. Generally, the so-called turbine-type fuel pump is adopted as the high pressure fuel pump 24.

A vapor eject pipe 32 is attached to the upper portion of the vapor separator 20 for ejecting vapor in the vapor separator 20 outside. The top end of the vapor eject pipe 32 is connected to an air-vent (not shown in figures). It is designed so that the vapor separated from the fuel in the vapor separator 20 eventually travels to the air-vent.

The pressure regulator 26 is connected to a high pressure filter 34 which is located outside the vapor separator 20 through a hose 22f. The high pressure filter 34 is connected to a delivery pipe 36 through a hose 22g. The delivery pipe 36 is directly connected to the injector 30. The high pressure filter 34, the delivery pipe 36, and the injector 30 are disposed at the outboard engine 14. The fuel accumulated in the vapor separator 20 travels to the injector 30 from the high pressure fuel pump 24 through the pressure regulator 26, the high pressure filter 34, and the delivery pipe 36, and is injected towards the engine (not shown in figures).

In the prior art shown in FIG. 4, the high pressure fuel pump 24 and the pressure regulator 26 are accommodated in the vapor separator 20. The high pressure fuel pump 24 supplies to the pressure regulator 26 more fuel than the amount of fuel fed to the injector 30 from the pressure regulator 26. Therefore, a part of the fuel supplied to the pressure regulator 26 from the high pressure fuel pump 24 is fed to the injector 30 as the amount of fuel necessary, and the remainder of the fuel is returned into the vapor separator 20 as surplus fuel. Here, the turbine-type fuel pump is adopted as the high pressure fuel pump 24.

With the turbine-type fuel pump in the prior art, the discharge amount cannot be controlled in accordance with the engine revolution. Therefore, the maximum fuel amount that the injector 30 injects must always be supplied. In this manner, since more than the needed amount of fuel for the injector 30 has to be fed towards the pressure regulator 26, there is a drawback that the pump becomes large and expensive. Further, since the high pressure fuel pump 24 is accommodated in the vapor separator 20, there is a drawback that the temperature of the fuel in the vapor separator 20 rises and vaporization of the fuel in the vapor separator 20 accelerates. To avoid these drawbacks, it is considered to dispose the high pressure fuel pump 24 and the pressure regulator 26 outside the vapor separator 20. Since the high pressure fuel pump 24 supplies the maximum amount of fuel that the injector 30 injects, surplus fuel is generated. Therefore, in this case, a fuel return passage for returning the surplus fuel from the pressure regulator 26 to the vapor separator 20 has to be disposed, and the drawback of high cost remains.

The present invention was devised in view of the abovementioned points. The object of the present invention is to provide a fuel supply system which can supply fuel accurately in accordance with the driving conditions, while achieving cost reduction by adopting an inexpensive pump without a fuel return passage for returning surplus fuel.

### DISCLOSURE OF THE INVENTION

To achieve the abovementioned object, in a fuel supply system to introduce fuel from a fuel tank to an injector through the order of a fuel pump and a pressure regulator of the present invention, the fuel pump discharges the amount of fuel in proportion to the engine revolution when below a specific engine revolution and discharges an almost constant amount when above the specific engine revolution, and a returnless pressure regulator is adopted as the pressure regulator. A fuel supply system of the present invention comprises a low pressure fuel pump which pressure is lower than the fuel pump and a vapor-liquid separating device between the fuel tank and the fuel pump, and the low pressure fuel pump discharges fuel from the fuel tank to the vapor-liquid separating device, and the fuel pump discharges fuel from the vapor-liquid separating device to the pressure regulator. In a fuel supply system of the present invention, the fuel pump is located above the low pressure fuel pump and the low pressure fuel pump is located above the vapor-liquid separating device. In a fuel supply system of the present invention, a positive displacement pump which intakes and discharges a specific volume of fluid is adopted as the fuel pump. In a fuel supply system of the present invention, a check valve is disposed either between the vapor-liquid separating device and the fuel pump or between the fuel pump and the pressure regulator.

### BRIEF DESCRIPTION OF THE DRAWINGS

FIG. 1 is a schematic diagram of the fuel supply system showing an embodiment of the present invention.

FIG. 2 is a characteristic diagram showing an example of the high pressure fuel pump utilized for the present invention.

FIG. 3 is a schematic diagram of the fuel supply system showing another embodiment of the present invention.

FIG. 4 is a schematic diagram of the fuel supply system for an outboard engine of the prior art.

### BEST MODE FOR CARRYING OUT THE INVENTION

With the present invention, the fuel pump adjusts and supplies the amount of fuel necessary for the injector in accordance with the engine driving conditions.

### The First Embodiment

The present invention is explained based on the drawings.

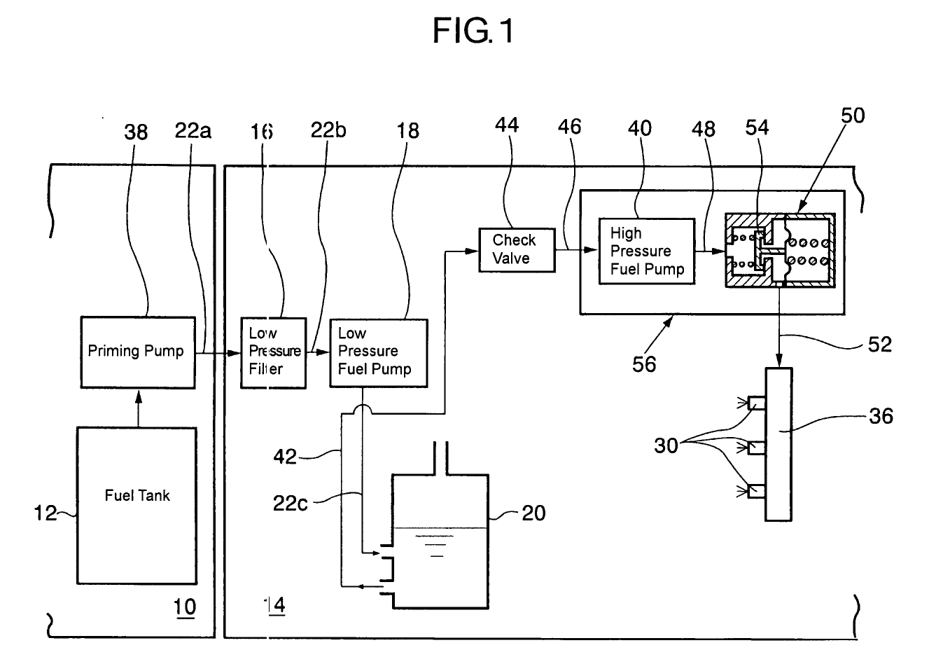

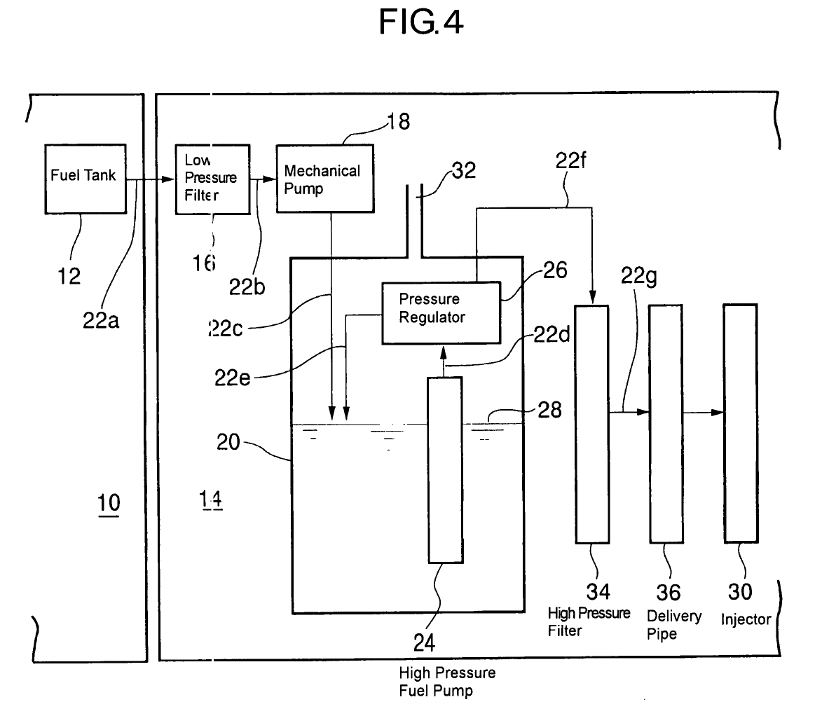

FIG. 1 shows a schematic drawing of the fuel supply system of the present invention and explains the case when it is adopted to an outboard engine. In the present invention, the same numeral shows the same member as FIG. 4. A fuel tank 12 and a pump (a priming pump) 38 are disposed at the hull 10 side. A low pressure filter 16 having a function to separate water, a low pressure fuel pump 18, and a vapor separator 20 as a vapor-liquid separating means are disposed at the outboard engine 14 side. The structure from the fuel tank 12 towards the vapor separator 20 is basically the same as the prior art.

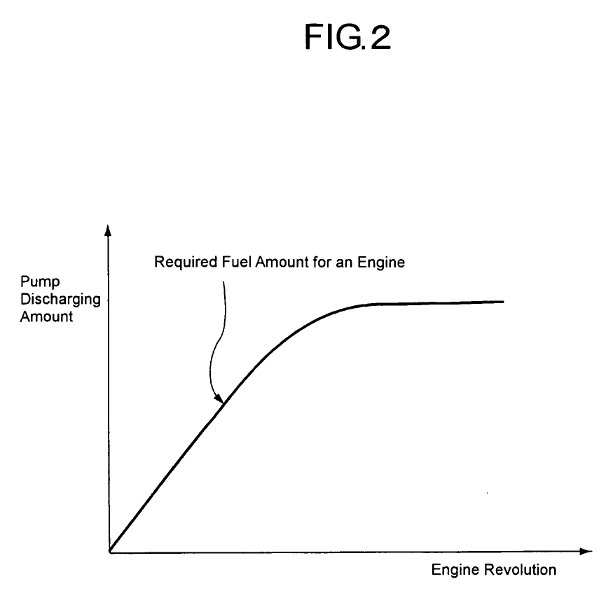

A fuel pump 40 (a fuel pump which fuel pressure is higher than the low pressure fuel pump 18) which is utilized in the present invention differs from the turbine-type fuel pump as in the prior art. Namely, the fuel pump 40 of the present invention is a positive displacement pump which intakes and discharges a specific volume of fluid. For example, it is a so-called mechanical pump which operates in cooperation with a crank shaft (an activating component) of an engine. The pump can adjust the fuel amount (the fuel pressure) to discharge to the injector 30 the amount of fuel that is injected through the injector 30 (the amount of fuel needed for the injector 30) in accordance with the engine driving conditions. Here, it may be an electromagnetic pump which can intake and discharge the amount of fuel in proportion to the engine revolution, and intake and discharge an almost constant amount of fuel when above a specific engine revolution. A plunger type pump is particularly preferred among the positive displacement pumps. The fuel pump 40 must be a pump which can control the amount of fuel discharged in accordance with the engine driving conditions. For example, as shown in FIG. 2, the pump has a structure that the fuel amount is in proportion to the engine revolution below a specific engine revolution, and is almost constant when above the specific engine revolution, namely a jamming mechanism. In other words, the discharging fuel amount is variable in accordance with the fuel amount which is needed for the engine.

In the present invention, the fuel pump 40 is disposed outside the vapor separator 20. The vapor separator 20 is connected to a check valve 44 through a hose 42. The check valve 44 is connected to the fuel pump 40 through a hose 46. Here, as described later, the location of the check valve 44 is not limited to the position between the vapor separator 20 and the fuel pump 40. The attaching position of the hose 42 to the vapor separator 20 for connecting with the fuel pump 40 is lower than the attaching position of the hose 22c to the vapor separator 20 for connecting with the low pressure fuel pump 18. With this structure, vapor is not to be contained in the fuel introduced to the fuel pump 40 from the vapor separator 20.

The fuel pump 40 is located at a position above the low pressure fuel pump 18 and the vapor separator 20. Further, the low pressure fuel pump 18 is located above the vapor separator 20. At the upper portion of the outboard engine 14, the temperature rises due to the influence of the sunlight which transmits through only a cover (not shown in figures). Therefore, the vapor separator 20 to separate vapor from fuel is disposed at the lowest position, and the fuel pump 40 just before the fuel injecting is located at a higher position than the low pressure fuel pump 18 which supplies fuel to the vapor separator 20. Namely, among the low pressure fuel pump 18 which has the possibility to generate vapor, the vapor separator 20, and the fuel pump 40, the fuel pump 40 which is close to the injector 30 to inject fuel is located at the highest position in the vertical direction, and the vapor separator 20 as a sub-tank is located at the lowest position in the vertical direction. With this structure, the generation of vapor is prevented to a minimum in the fuel passage of the fuel supply system of the present invention.

The fuel pump 40 is connected to a returnless pressure regulator 50 through a hose 48. The returnless pressure regulator 50 is connected to a delivery pipe 36 which has the injector 30 through a hose 52. As the pressure regulator of the present invention, the returnless pressure regulator 50 which controls the pressure of the downstream side thereof and discharges to the injector 30 the exact amount of the introduced fuel is adopted. With this structure, since fuel does not return to the vapor separator 20, there is no necessity to dispose a fuel return passage. A valve 54 is disposed in the returnless pressure regulator 50. When the pressure at the injector 30 drops, the valve 54 opens to supply fuel to the injector 30. In this manner, the fuel pressure at the injector 30 is adjusted.

It is preferred to mount the low pressure fuel pump 18 at the lower area of the cylinder head (not shown in figures) of the engine. Further, it is preferred to integrally form the fuel pump 40 and the returnless pressure regulator 50, and to fix the integrally formed structure 56, which is the fuel pump 40 and the returnless pressure regulator 50, to the engine cylinder head (not shown in figures) of the engine. Here, the integrally formed structure 56 includes a fixing member to fix the fuel pump 40 and the returnless pressure regulator 50 with a housing (not shown in figures). By forming the fuel pump 40 and the returnless pressure regulator 50 as the integrally formed structure 56, the two parts can be disposed closely. Then, the hose 48 for connecting the fuel pump 40 and the returnless pressure regulator 50 can be eliminated or can be extremely short. At the outboard engine 14 side, the hoses 42, 46, 48, 52 as the connecting means between the vapor separator 20 and the injector 30 are all respectively shortened to a minimum or eliminated. In this manner, the distance from the vapor separator 20 to the injector 30 can be shortened, and the structure of the fuel line can be simplified, while preventing the vaporization of the fuel to a minimum.

The present invention differs from the prior art as in FIG. 4 as follows. The fuel pump 40 which is a positive displacement pump and intakes and discharges a specific volume of fluid is located outside the vapor separator 20, and the fuel amount discharged from the fuel pump 40 can be adjusted to the amount of fuel needed for the injector 30 to inject. The pressure regulator is the returnless pressure regulator 50 for controlling the pressure of the downstream side thereof. Namely, in the present invention, by changing the position of the fuel pump 40 to the outside of the vapor separator 20, the temperature of the fuel in the vapor separator 20 can be lower compared with the conventional system which has a high pressure fuel pump located in the vapor separator 20. Further, by adopting a positive displacement fuel pump as the fuel pump 40, cost reduction can be achieved compared with a turbine-type fuel pump of the prior art.

In the present invention, a positive displacement pump which intakes and discharges a specific volume of fuel is adopted as the fuel pump 40, and the amount of fuel needed for the injector 30 is discharged from the fuel pump 40 by adjusting the fuel amount. Further, in the present invention, fuel is supplied to the injector 30 through the returnless pressure regulator 50 which adjusts the fuel pressure at the injector 30, namely, to supply the amount of fuel injected from the injector 30, when the pressure at the injector 30 drops after fuel is injected from the injector 30. With this structure, unlike the prior art, the fuel pump 40 does not discharge to the returnless pressure regulator 50 more fuel amount than is needed for the injector 30. Then, there is no need for returning fuel from the pressure regulator to the vapor separator 20 unlike the prior art. Therefore, in the present invention, there is no need for disposing a return passage between the pressure regulator and the vapor separator 20 even when the pressure regulator is disposed outside the vapor separator 20.

In the present invention, by locating the fuel pump 40 outside the vapor separator 20, the distance between the fuel pump 40 and the returnless pressure regulator 50 can be shortened or can be the integrally formed structure 56 in some cases. By shortening the distance between the fuel pump 40 and the returnless pressure regulator 50, the generation of vapor at the fuel passage from the fuel pump 40 to the injector 30 can be prevented, and the structure of the fuel line can be simplified. Further, air in the fuel passage can immediately be ejected to the outside, even when there is no fuel at some midpoint of the fuel passage. Therefore, easiness for starting can be improved.

Here, the fuel pump 40 being a positive displacement pump has the function as a check valve. However, taking the variation of the pump performance into account, there is a check valve 44 disposed between the vapor separator 20 and the fuel pump 40 as shown in FIG. 1. The check valve 44 is not necessarily needed considering that the pump performance improves. The check valve 44 can also be disposed between the fuel pump 40 and the returnless regulator 50, and not between the vapor separator 20 and the fuel pump 40. In this case, the integrally formed structure 56 can be formed by three components which are the fuel pump 40, the check valve 44, and the returnless pressure regulator 50. In the case that the check valve 44 is disposed at the vapor separator 20 side than the fuel pump 40, the integrally formed structure 56 is formed by two components which are the fuel pump 40 and the returnless pressure regulator 50. In this case, the fuel line can be further simplified by further shortening the distance between the fuel pump 40 and the returnless pressure regulator 50.

In the abovementioned explanation, components are connected by hoses 22b, 22c, 42, 46, 48, 52 as connecting means. However, the connecting means are not limited to these hoses.

### The Second Embodiment

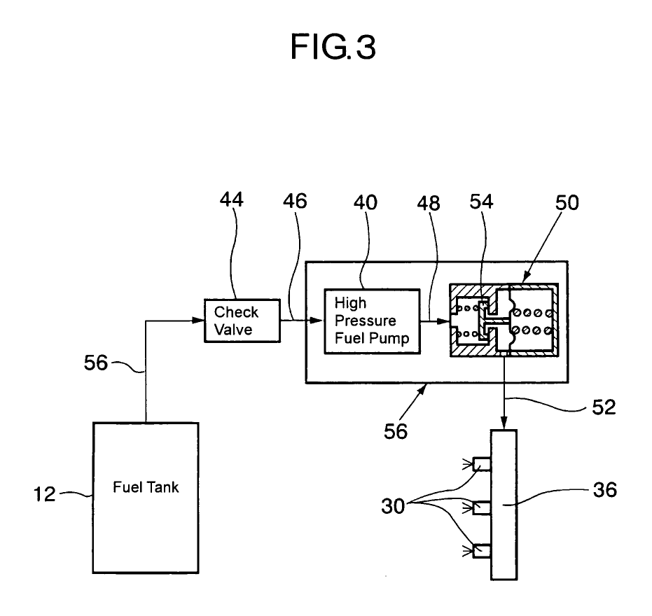

The schematic diagram of the second embodiment of the fuel supply system of the present invention is shown in FIG. 3. In the first embodiment, the fuel supply system is adopted to a marine vehicle such as an outboard engine. In the second embodiment, it is adopted to a land vehicle such as an automobile etc. In FIG. 3, the same numeral is given to the same member as in FIG. 1. The second embodiment is different from the first embodiment in that the vapor separator 20 and the low pressure fuel pump 18 etc. which are utilized in the first embodiment are eliminated. In the second embodiment, because the vapor separator 20 and the low pressure fuel pump 18 etc. of the first embodiment are eliminated, the fuel tank 12 is connected to the check valve 44 through the hose 56. The check valve 44 is connected to the fuel pump 40 through the hose 48. The fuel pump 40 is connected to the returnless pressure regulator 50 through the hose 48. The returnless pressure regulator 50 is connected to the delivery pipe 36 having the injector 30 through the hose 52. The connecting structure from the check valve 44 to the injector 30 is the same as the first embodiment. Further, it is possible to eliminate the check valve 44 or to locate the check valve 44 at a different position.

In the second embodiment, the positive displacement pump which intakes and discharges a specific volume of fluid is also adopted as the fuel pump 40. With this pump, it is possible to adjust the amount of fuel (the fuel pressure) to discharge to the injector 30 the fuel amount injected from the injector 30 in accordance with the engine driving conditions, namely, the fuel amount needed for the injector 30. As shown in FIG. 2, the fuel pump 40 has a structure that the discharging fuel amount is in proportion to the engine revolution below a specific engine revolution, and is almost constant when above the specific engine revolution, namely a jamming mechanism. For example, it is a so-called mechanical pump which operates in cooperation with a crank shaft (an activating component) of an engine, or it is an electromagnetic pump which can intake and discharge the amount of fuel in proportion to the engine revolution and intake and discharge an almost constant amount when above the specific engine revolution. In addition, a plunger type pump is preferred among the positive displacement pumps. Further, the returnless pressure regulator 50 which controls the pressure of the downstream side thereof and discharges to the injector 30 the exact amount of the introduced fuel is adopted.

As explained above, in the second embodiment, a positive displacement pump is also adopted as the fuel pump 40 and supplies the fuel amount needed for the injector 30. Therefore, there is no need to supply surplus fuel, and it is possible to adopt a pump which is small and inexpensive compared to a turbine-type fuel pump of the prior art. Further, since the fuel pump 40 discharges only the amount of fuel that the injector 30 needs, the pressure regulator 50 can be the returnless pressure regulator 50. Therefore, the fuel return passage from the pressure regulator to the outside which is conventionally needed can be eliminated.

### INDUSTRIAL APPLICABILITY

Conventionally, more fuel than needed for an injector is supplied to a pressure regulator by a turbine-type fuel pump. Therefore, the turbine-type fuel pump and the pressure regulator have to be accommodated in a vapor separator, or a fuel return passage has to be disposed between the pressure regulator and the vapor separator when the turbine-type fuel pump and the pressure regulator are located at the outside of the vapor separator. In the present invention, a positive displacement pump which intakes and discharges a specific volume of fluid is adopted as the fuel pump, and discharges the amount of fuel just needed for the injector. Then, the discharged fuel from the fuel pump is supplied to the injector through a returnless pressure regulator. In this manner, the cost of the fuel pump is reduced, and the fuel return passage connecting the pressure regulator and the vapor separator can be eliminated. In addition, when the present invention is utilized to an outboard engine, the temperature of the fuel in the vapor separator can be prevented from rising by locating the fuel pump outside the vapor separator.

1. A fuel supply system to introduce fuel from a fuel tank to an injector through the order of a fuel pump and a pressure regulator:
wherein said fuel pump discharges the amount of fuel in proportion to the engine revolution when below a specific engine revolution and discharges an almost constant amount when above the specific engine revolution; and
wherein a returnless pressure regulator is adopted as said pressure regulator.

2. The fuel supply system according to claim 1:
comprising a low pressure fuel pump which pressure is lower than said fuel pump and a vapor-liquid separating device between said fuel tank and said fuel pump;
wherein said low pressure fuel pump discharges fuel from said fuel tank to said vapor-liquid separating device, and said fuel pump discharges fuel from said vapor-liquid separating device to said pressure regulator.

3. The fuel supply system according to claim 2, wherein said fuel pump is located above said low pressure fuel pump, and said low pressure fuel pump is located above said vapor-liquid separating device.

4. The fuel supply system according to claim 1, wherein a positive displacement pump which intakes and discharges a specific volume of fluid is adopted as said fuel pump.

5. The fuel supply system according to claim 1, wherein a check valve is disposed either between said vapor-liquid separating device and said fuel pump or between said fuel pump and said pressure regulator.
